(19) United States
(12) Patent Application Publication
(10) Pub. No.: US 2010/0300088 A1
(43) Pub. Date: Dec. 2, 2010

(54) METHOD OF CONTROLLING A TURBOCHARGER

(75) Inventors: Volker Joergl, Ortonville, MI (US); Olaf Weber, Bloomfield Hills, MI (US)

Correspondence Address: REISING, ETHINGTON, BARNES, KISSELLE, P.C., P. O. BOX 4390, TROY, MI, 48099-4390, US

(73) Assignee: BORGWARNER INC., Auburn Hills, MI (US)

(21) Appl. No.: 12/599,316

(22) PCT Filed: May 13, 2008
(86) PCT No.: PCT/US08/63518

§ 371 Date: Nov. 9, 2009

Related U.S. Application Data
(60) Provisional application No. 60/917,735, filed on May 14, 2007.

(51) Int. Cl. F02D 23/00

(52) U.S. Cl. 60/602

(57) ABSTRACT

Another embodiment of the invention includes a method of controlling a turbocharger to achieve at least one of: produce air in excess of that required to operate a combustion engine at a specific power demand; control the flow of gas through the turbine; or control the turbine speed independent of boost pressure required to avoid specific speeds.

This application claims the benefit of U.S. Provisional Application Ser. No. 60/917,735, filed May 14, 2007.

### TECHNICAL FIELD

The field to which the disclosure generally relates includes combustion engine breathing systems, components thereof, turbocharger systems and components and methods of making and using the same.

### BACKGROUND

FIG. 1 is a schematic illustration of a product or system 10 including a modern breathing system used for a single stage turbocharger. Such a system may include a combustion engine 12 constructed and arranged to combust a fuel, such as, but not limited to, a diesel fuel in the presence of oxygen. The system 10 may further include a breathing system including an air intake side 14 and a combustion gas exhaust side 16. The air intake side 14 may include a manifold 18 connected to the combustion engine 12 to feed air into the cylinders of a combustion engine 12. A primary air intake conduit 20 may be provided and connected at one end to the air intake manifold 18 (or made apart thereof), and may include an open end 24 for drawing air therethrough. An air filter 26 may be located at or near the open end 24 of the air intake conduit 20.

The combustion gas exhaust side 16 may include an exhaust manifold 28 connected to the combustion engine 12 to exhaust combustion gases therefrom. The exhaust side 16 may further include a primary exhaust conduit 30 having a first end 32 connected to the exhaust manifold 28 (or made apart thereof) and having an open end 34 for discharging exhaust gas to the atmosphere.

Such a system may further include a first exhaust gas re-circulation (EGR) assembly 40 extending from the combustion gas exhaust side 16 to the air intake side 14. A first EGR valve 46 may be provided in fluid communication with the primary exhaust gas conduit 30 and constructed and arranged to flow the exhaust gas from the exhaust side 16 to the air intake side 14 and into the combustion engine 12. The first EGR assembly 40 may further include a primary EGR line 42 having a first end 41 connected to the primary exhaust gas conduit 30 and a second end 43 connected to the air intake conduit 30. A cooler 44 may be provided in fluid communication with the primary EGR line 42 for cooling the exhaust gas flowing therethrough.

The system 10 may further include a turbocharger 48 having a turbine 50 in fluid communication with the primary exhaust conduit 30 and having a compressor 52 in fluid communication with the primary air intake conduit 20 to compress gases flowing therethrough. An air charge cooler 56 may be provided in the primary air intake conduit 20 downstream of the compressor 52. In one embodiment the compressor 52 may be a variable pressure compressor constructed and arranged to vary the pressure of the gas at a given flow rate. A throttle valve may be provided in the primary air intake conduit 20 downstream of the compressor 52 and upstream of the union of the primary EGR line 42.

A number of emission control components may be provided in the primary exhaust conduit line 30 typically downstream of the turbine 50. For example, a particulate filter 54 may be provided downstream of a turbine 50. Other emission control component such as a catalytic converter 36 and a muffler 38 may also be provided downstream of the turbine 50. Further exhaust after treatment devices such as lean NOₓ traps may also be provided.

A number of challenges have been associated with the use and operation of system such as that described above. For example, it is desirable to achieve low engine out NOₓ levels. Such requires relatively high EGR flow rates. It is further desirable for the EGR gas to be cooled prior to entering the combustion engine 12. Under certain operating conditions, the radiator may not be sufficiently sized to provide adequate cooling of the EGR gases.

Furthermore, at many operating points of the engine map, the turbocharger turbine, heretofore, has not been operated with optimal efficiency. Still further, operating the turbine at a higher efficiency may lead to excess turbine power that may not be utilized. In other operating scenarios, excess energy from the exhaust gases bypassed around the turbine, passes out the open end 34 of the exhaust conduit 30 and is lost. In such situations excess exhaust energy is therefore relatively available, but cannot be used.

Still further, in some scenarios the turbocharger turbine has been operated in an inefficient area to achieve certain EGR rates and therefore certain NOₓ emissions. The EGR flow rate and turbine power (due to exhaust gas flow through the turbine) are closely coupled which under a variety of scenarios may be undesirable.

Still further, all turbochargers have speed areas, wherein frequencies or resonance in the turbocharger can cause severe damage or even cause a turbocharger to fail. Heretofore, such resonances have been avoided by increasing the tolerance gaps between components which leads to a less sufficient turbocharger.

### SUMMARY OF EXEMPLARY EMBODIMENTS OF THE INVENTION

A method comprising operating a combustion engine breathing system including an air intake side, an exhaust side, a turbocharger comprising a turbine in fluid communication with the exhaust side and a compressor in fluid communication with the air intake side, and the air breathing system including at least one other component; operating the turbocharger at a speed greater than that required to supply air to a combustion engine, and supplying excess air not required by the combustion engine to at least one other component of the combustion engine breathing system.

Another embodiment of the invention includes a method of controlling a turbocharger to achieve at least one of: produce air in excess of that required to operate a combustion engine at a specific power demand; control the flow of gas through the turbine; or control the turbine speed independent of boost pressure required to avoid specific speeds.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a prior art engine breathing system.

FIG. 2 is a schematic illustration of an engine breathing system according to one embodiment of the invention.

FIG. 3 illustrates a turbine with variable geometry useful in embodiment of the invention.

FIG. 4 illustrates an enlarged view of a portion of the turbine of FIG. 3.

FIG. 5 is a graph illustrating the relationship between turbine vane position and turbine efficiency of a turbocharger useful in one embodiment of the invention.

FIG. 6 is a logic flow chart illustrating a method according to one embodiment of the invention.

FIG. 7 is a graph illustrating a region of undesirable turbocharger speeds.

FIG. 8 is a logic flow chart illustrating a method according to one embodiment of the invention.

FIG. 9 is a schematic illustration of a method of controlling a turbocharger to avoid a resonance area during in increase in engine air flow according to one embodiment of the invention.

FIG. 10 is a schematic illustration of a method of controlling a combustion engine breathing system including changing the vane angle of a variable geometry turbine to jump past a resonance speed and adjusting a recirculation value position, bleed off valve position or variable compressor actuator position.

FIG. 11 is a schematic illustration of a method of controlling a turbocharger to avoid a resonance area during a decrease in engine air flow according to one embodiment of the invention.

FIG. 12 is a schematic illustration of an engine breathing system according to one embodiment of the invention.

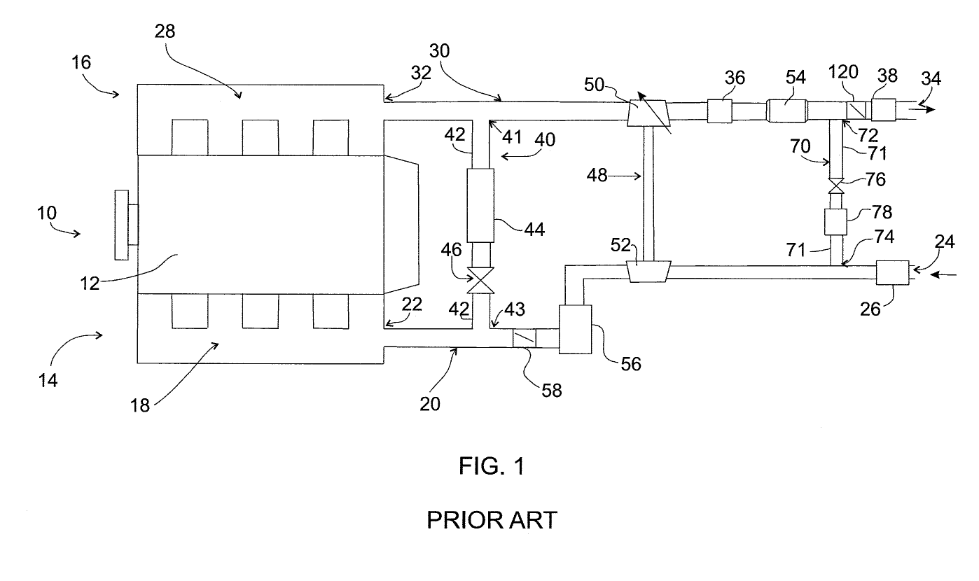

### DETAILED DESCRIPTION OF EXEMPLARY EMBODIMENTS

The following description of the embodiment(s) is merely exemplary in nature and is in no way intended to limit the invention, its application, or uses.

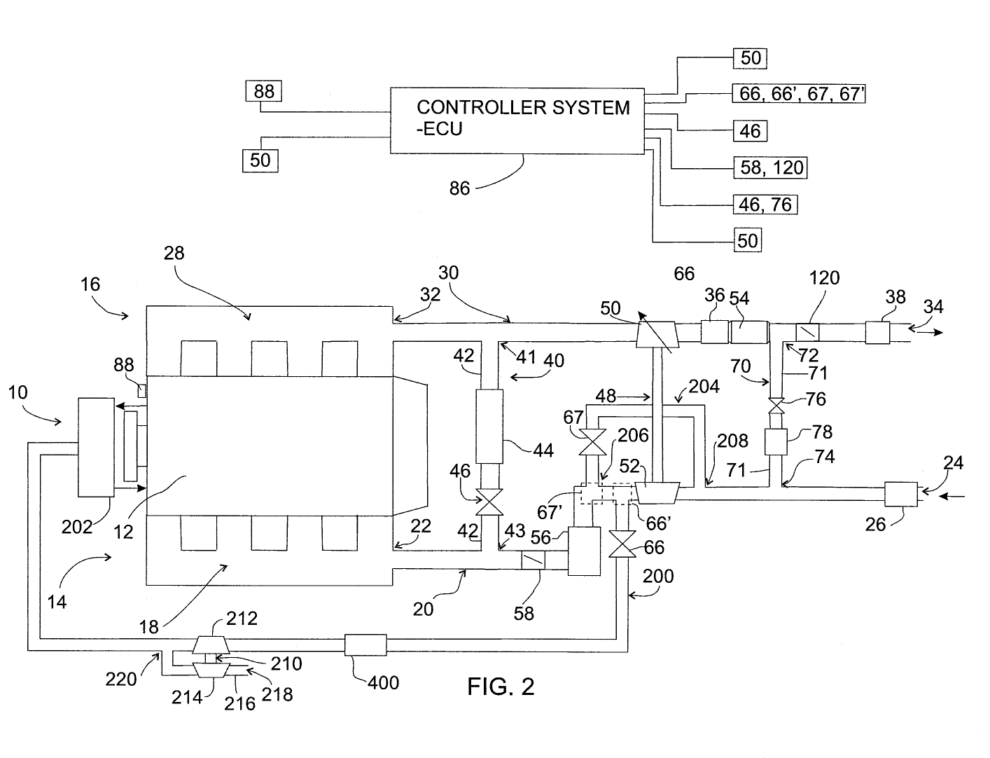

Referring now to FIG. 2, one embodiment of the invention includes a product or system 10 which may include one or more of the following components. The system 10 may include a combustion engine 12, such as, but not limited to a diesel combustion engine. An air intake side 14 may be provided including a manifold 18 connected to the combustion engine to feed air into the cylinders of a combustion engine 12. A primary air intake conduit 20 may be provided and connected at one end 22 to the air intake manifold 20 (or made apart thereof), and may include an open end 24 for drawing air therethrough. An air filter 26 may be located at or near the open end of the air intake conduit 20.

A combustion gas exhaust side 16 may be provided and constructed and arranged to discharge combustion exhaust from the combustion engine 12. The combustion exhaust side 16 may include an exhaust manifold 28 connected to the combustion engine 12 to exhaust combustion gases therefrom. The exhaust side 16 may further include a primary exhaust conduit 30 having a first end 32 connected to the exhaust manifold 28 (or made apart thereof), and may have an open end 34 for discharging exhaust gases to the atmosphere.

The system 10 may further include a first exhaust gas re-circulation (EGR) assembly 40 extending from the combustion exhaust side 16 to the air intake side 14. A first EGR valve 46 may be provided in fluid communication with the primary exhaust gas conduit 30 or may be provided in a primary EGR line 42 and constructed and arranged to control the flow of exhaust gas through the primary EGR line, into the air intake side 14 and into the combustion engine 12. A cooler 44 may be provided in fluid communication with the first primary EGR line 42 for cooling exhaust gases flowing through the same.

The system 10 may further include a turbocharger 48 having a turbine 50 in fluid communication with the primary exhaust conduit 30 and having a compressor 52 in fluid communication with the primary air intake conduit 20 to compress gases flowing therethrough. In one embodiment of the invention, the turbine 50 may have a variable turbine geometry with turbine vanes movable from at least a first position to a second position to vary the geometry of a turbine and thus vary the speed of rotation of the turbine for a given flow rate therethrough. Variable geometry turbine devices are well known to those skilled in the art. Examples of variable geometry turbine devices useful in various embodiments of the invention are described in Scholz et al., U.S. Pat. No. 7,114,919, issued Oct. 3, 2006; Marcis et al, U.S. Pat. No. 7,137,778, issued Nov. 21, 2006; and Stilgenbauer, U.S. Pat. No. 7,010,915, issued Mar. 14, 2006.

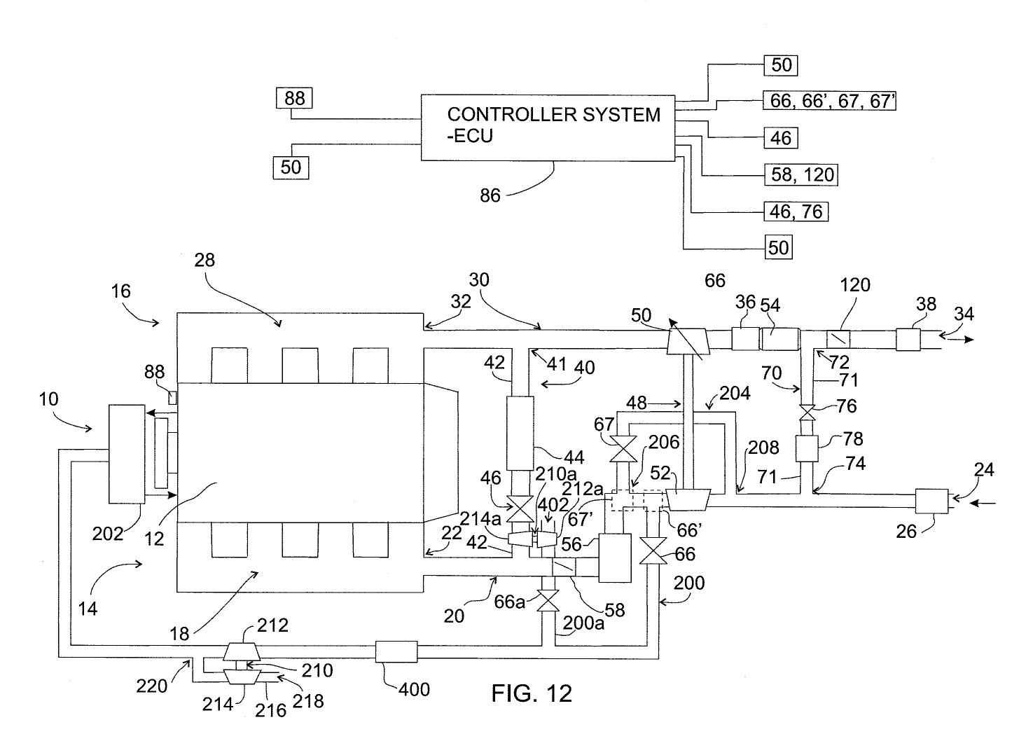

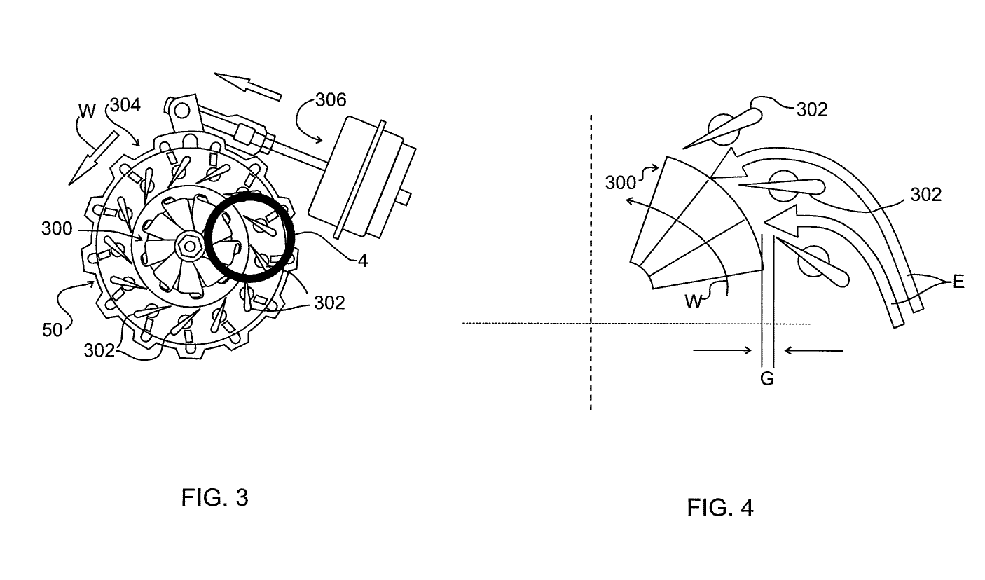

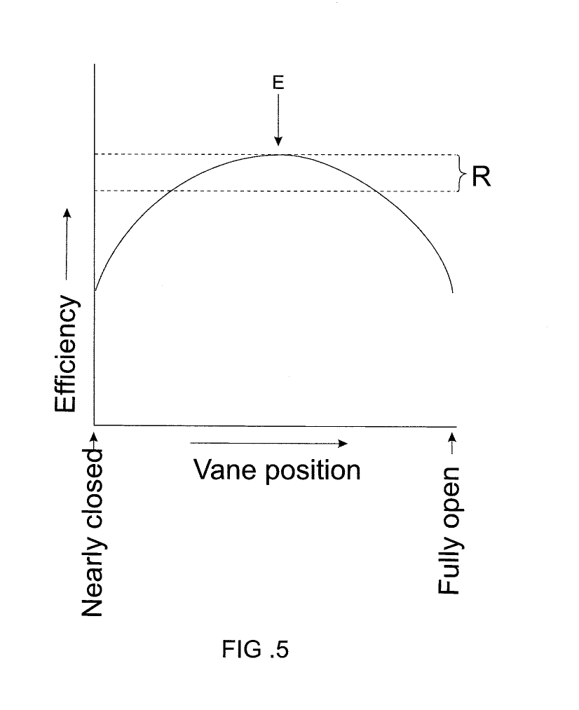

FIGS. 3-4 illustrate a turbine 50 with a variable geometry including a rotatable turbine wheel 300 and a plurality of movable vanes 302 around the periphery of the wheel 300. A mechanism 304 is connected to each turbine vane 203 and to an actuator 306 to move the vanes to multiple positions anywhere from fully open to nearly closed or closed positions. The moveable vanes 302 direct exhaust gas (Arrows E) onto the turbine wheel 300. The vanes 302 may be moved to a nearly closed position to provide a very narrow passage for the exhaust gas to flow through thereby accelerating the exhaust toward the turbine blades and to hit the turbine blades at a proper angle to rotate the turbine wheel 300 in the direction indicated by arrow W. Such a position of the vanes is optimized for low engine RPM speeds. The vanes 302 may be moved to a fully opened position to direct high exhaust flows at high engine speeds. The optimum efficiency of the turbine 50 typically occurs at a position of the vanes 302 somewhere between the nearly closed and fully open positions as shown in FIG. 5.

Referring now to FIG. 4, because the turbine 50 may be operated in a manner that avoids undesirable frequencies according to embodiments of the invention that will be described later, the gap G of clearance between the turbine wheel 300 and the vanes 302 may be relatively close thereby improving the efficiency of the variable geometry turbine 50.

Referring again to FIG. 2, a second EGR assembly 70 may be provided for low-pressure exhaust gas re-circulation. The second EGR assembly 70 may be identically constructed as the first EGR assembly 40, if desired. In one embodiment, the second EGR assembly includes a second EGR line 71 having a first end 72 connected to the primary exhaust conduit 30 and a second end 74 connected to the primary air intake conduit 20. A second EGR valve 76 may be provided in fluid communication with the primary EGR conduit or provided in the second EGR line 71. A second cooler 76 may be provided in fluid communication with the second EGR line 71 to cool exhaust gas flowing therethrough. The primary exhaust gas conduit 30 may also include a throttle valve 120 to control the amount of exhaust gas being exhausted through the open end and to force exhaust gas to flow through the second EGR line 71.

Additional components may be included in the primary exhaust conduit 30 including a particulate filter 54 located downstream of the turbine 50. A catalytic converter 36 may be located upstream of the particulate filter 54 and a muffler 38 may be located downstream of the particulate filter 54.

According to one embodiment of the invention, an excess air conduit 200 may be connected to the primary air intake conduit 20 downstream of the compressor 52. The excess air conduit 200 may be plumbed to provide air to any of a variety of components in the system including, but not limited to, a radiator 202 used to cool engine cooling fluid. The excess air conduit 200 may also be plumbed to other components including, but not limited to, coolers 44, 56, 78, or to other components including injecting air into the primary exhaust conduit 30 at a variety of locations including, but not limited to, in front of the particulate filter 54. The excess air conduit 200 may also be plumbed to a second turbocharger 210 including a turbine 212 in fluid communication with the excess air conduit 200 to reduce the pressure of the gas therein and at the same time cool the gas flowing through the excess air conduit 200 downstream of the second turbine 212. The second turbocharger 210 may also include a compressor 214 in fluid communication with an auxiliary air conduit 218 which may have a first end 216 which may be open to the atmosphere and a second end 220 which may be joined to the excess air conduit 200 downstream of the second turbine 210 or the second end 220 of the auxiliary air conduit 216 may be plumbed to provide air to another component in the system.

Flow through the first excess air conduit 200 may be controlled by a variety of means including, but not limited to, a control valve 66 provided in the first excess air conduit 200 or by a three way valve 66′ located at the juncture of the primary air intake 20 and the first excess air conduit 200. Optionally, a cooler 400 may be provide in fluid communication with the excess air conduit 200 to cool air flowing there through.

A second cooler 56 may be provided in fluid communication with the primary air intake line 20 and located downstream of the compressor 52. Optionally, an air throttle valve 58 may be located in the air intake line 20, preferably downstream of the second cooler.

In another embodiment of the invention a second or alternative excess air conduit 204 may be provided having a first end 206 connected to the primary air intake conduit 20 at a location downstream of the compressor 52. A second end 208 of the second excess air conduit 204 may be connected to the primary air intake conduit 20 at a location upstream of the compressor 52. Such an arrangement allows for the turbine 50 to be operated at a speed that is less detrimental to the turbo charger 48. The speed of rotation of the turbine 50 may be increased in a manner to cause the air output from the compressor 52 to be in excess of that required (i.e., demanded) by the combustion engine 12. Excess air not needed by the engine 12 may be circulated back into the air intake 20 at a position upstream of the compressor 52. Flow through the second excess air conduit 204 may be controlled by any of a variety of means, including but not limited to, a control valve 67 which may be positioned in the second excess air conduit 204 or a three way valve 67′ which may be located at the junction of the primary air intake 20 and the second excess air conduit 204.

A controller system, such as an electronic control module or unit 86 may be provided and may receive input from a variety of sensors, or other controllers or the like, including an engine sensor 88 which may provide signals regarding the engine speed or load. The ECU 86 may receive input from a variety of other sensors or other devices in the system including, but not limited to, air mass flow sensors in the primary air conduit 20, exhaust gas flow sensors in the primary exhaust gas conduit 30, flow and temperature sensors located in the primary EGR line 42 or the second EGR line 71, or any other device capable of providing input to the ECU regarding the operating condition of any other component in the system. The ECU 86 may utilize such information to provide an output such as, but not limited to, signals to control the turbine 50, control valves 66, 66′, 67, 67′ throttle valves 58, 120 or EGR valves 46, 47.

Referring now to FIG. 12, in another embodiment a second or alternative turbocharger 210a may be provide including a turbine 212a and a compressor 214a. The turbine 212a in connected to an excess air conduit 200a and the compressor 214a is connected to one of the EGR lines 42 or 71 to pump ERG gas through one of the EGR lines 42 or 71. A valve 66a may be provided to control the flow of excess through the excess air conduit 200a. An end 402 of the excess air conduit 200a may be open to the atmosphere or may be connected to another component of the system to deliver air thereto.

FIG. 5 is a graph depicting the relationship of turbocharger efficiency to the vane position of the variable geometry turbine. Typically the variable geometry turbochargers include a turbine having movable vanes movable from a nearly closed position to a fully open position to thereby vary the speed of rotation of the turbine and thereby the output of the compressor. Typically, such variable geometry turbochargers are designed such that the turbine is most efficient when the vanes are at a position somewhere between nearly closed and fully open. For example, line E designates a general area where the turbine is most efficient. According to one embodiment of the invention, the turbine is operated in a predetermined range R of the optimum efficiency. For example, the turbine may be selectively operated within ten percent of the optimum efficiency design for the turbine. At the same time, the turbine retains the flexibility to operate at less efficient conditions where the vane positions are more nearly closed or more nearly fully open. For example, the vane position may be adjusted to help reduce turbo lag at low engine speeds or to take advantage of high exhaust flow at high engine speeds. The vane position of the turbine may be adjusted so that the turbine operates within, for example, 90-100 percent efficiency. This may result in an output from the compressor 52 which provides a volume of air in excess of or which is deficient of the amount of intake gas required to operate the combustion engine at a power level demanded by the operator of a vehicle. If excess air is produced by the compressor 52, the excess air may be delivered to another component in the vehicle through, for example, the first excess air conduit 200 and/or the second excess air conduit 204. If the amount of air or the flow rate of air out of the compressor 52 is deficient or less than the volume of intake gas required to operate the combustion engine at a power level demanded by the operator of a vehicle, additional make up gases may be provided through the first exhaust gas recirculation line 42 or through the second exhaust gas circulation line 71.

In still another embodiment, the speed of the turbine may be adjusted to achieve an improvement in efficiency within a predetermined target range. In one embodiment the improvement in efficiency may be up to 30 percent. In another embodiment the speed of the turbine may be adjusted to achieve an improvement in efficiency ranging from about 1 to about 30 percent.

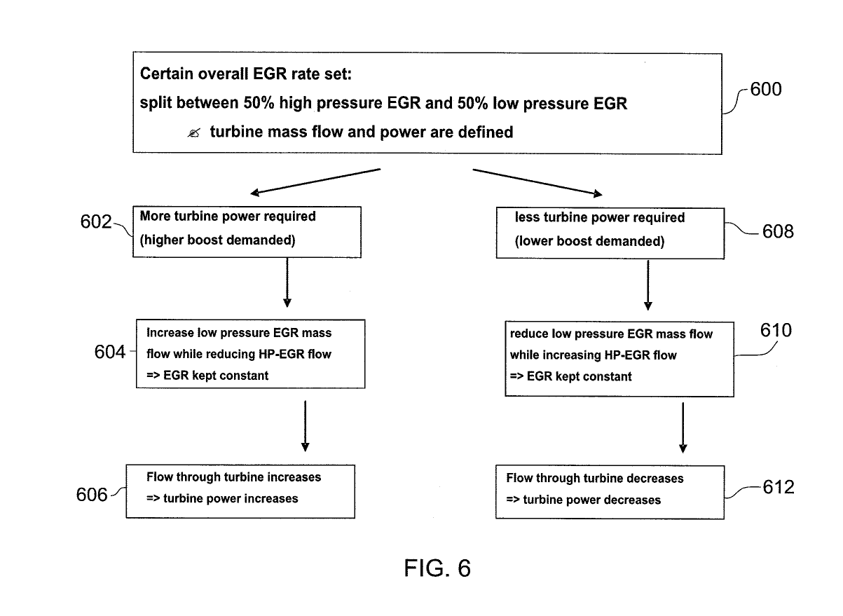

In one embodiment of the invention, the total amount of recirculated exhaust gas entering into the combustion engine 12 may be provided by apportioning or splitting the flow of exhaust gas through the high pressure EGR line 42 and the low pressure EGR line 71. For example, FIG. 6 illustrate a method of operating a combustion engine breathing system with a overall EGR rate and a split between 50% high pressure EGR and 50% low pressure EGR 600. The system is operated such that if more turbine power is required (higher boost demand from the compressor) 602, then the low pressure EGR mass flow rate is increased while reducing the high pressure EGR flow rate so that the total EGR flow rate into the combustion engine is kept constant 604. This results in an increase in the flow through the turbine resulting in increased turbine power. Conversely, if there is a decrease in the turbine power demand 608, the low pressure EGR mass flow rate is reduced while the high pressure EGR flow rate is increased 610. This results in the flow through the turbine decreasing thereby decreasing turbine power output 612.

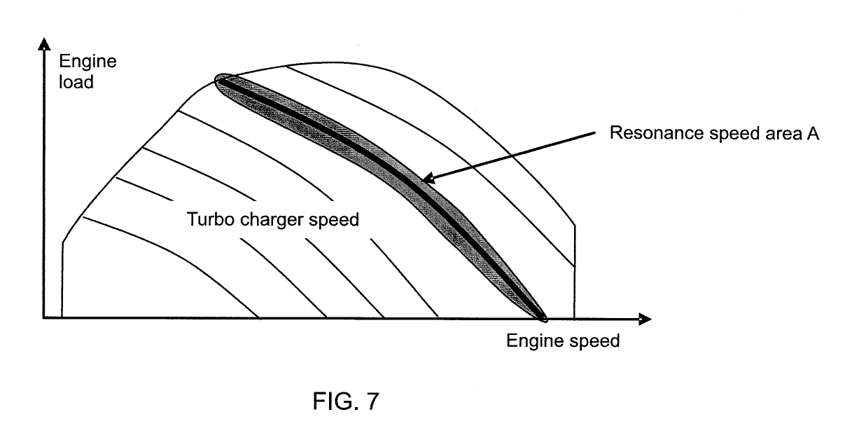

In another embodiment of the invention, the turbocharger may be operated so that the speed of the turbine is within the range of acceptable speeds or frequencies. An acceptable speed or frequency is a speed or frequency of the turbine that does not result in damage to the turbocharger. Conversely, the turbine may be operated so that speeds that have unacceptable modes of resonance are avoided. FIG. 7 is a graph of engine load verse engine speed and associated turbocharger turbine speed. A region or range of undesirable turbine speeds is shown as Area A which may include undesirable modes of resonance. As the exhaust output of the combustion engine varies, the speed at which the turbine rotates will vary proportionately provided that the position of the vanes remains constant. As the speed of the turbine changes with operation of the combustion engine the speed of the turbine may be controlled by adjusting the vane position so that undesirable speeds, having an unacceptable frequency associated therewith, may be avoided. That is, the position of the turbine vanes may be adjusted to rapidly increase or decrease the speed to jump past or through certain undesirable speeds and thereby avoid undesirable bending modes without negatively impacting overall engine performance.

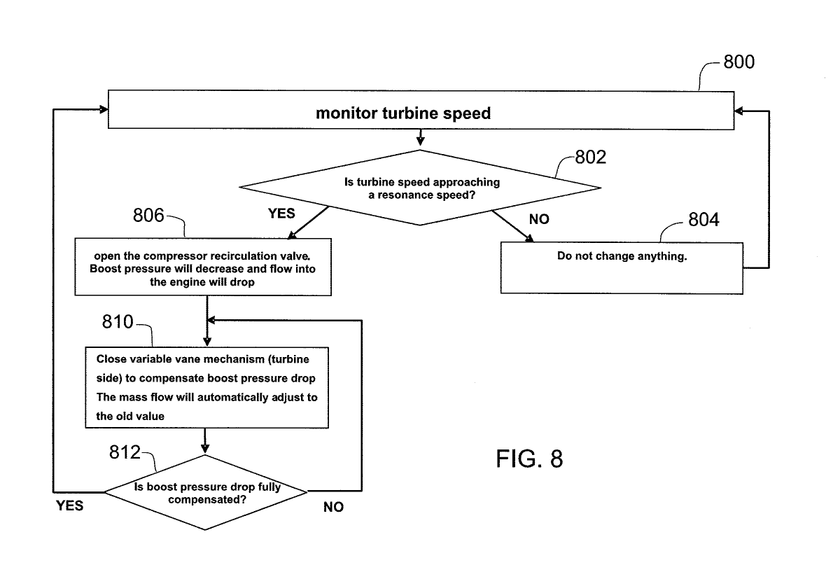

Referring now to FIG. 8, one embodiment of the invention includes a method of operating a turbine or turbocharger including the step 800 of continuously monitoring turbine speed. In a second step 802, a comparison is made to determine if the turbine speed is approaching an undesirable speed or undesirable resonance speed. If no, then the speed of the turbine is not adjusted 804. In another step 806, if the turbine speed is approaching an undesirable speed or undesirable resonance speed then the compressor recirculation valve (67, 67′) is opened so that boost pressure decreases and flow into the engine will drop. In another step 810, thereafter or simultaneously, the variable vane mechanism of the turbine is moved in the direction of the nearly closed position to compensate for the boost pressure drop. In another step 812, a comparison is made to determine if the boost pressure drop has been fully compensated for. If yes, the monitoring of the turbine speed continues. If no, then step 810 is repeated.

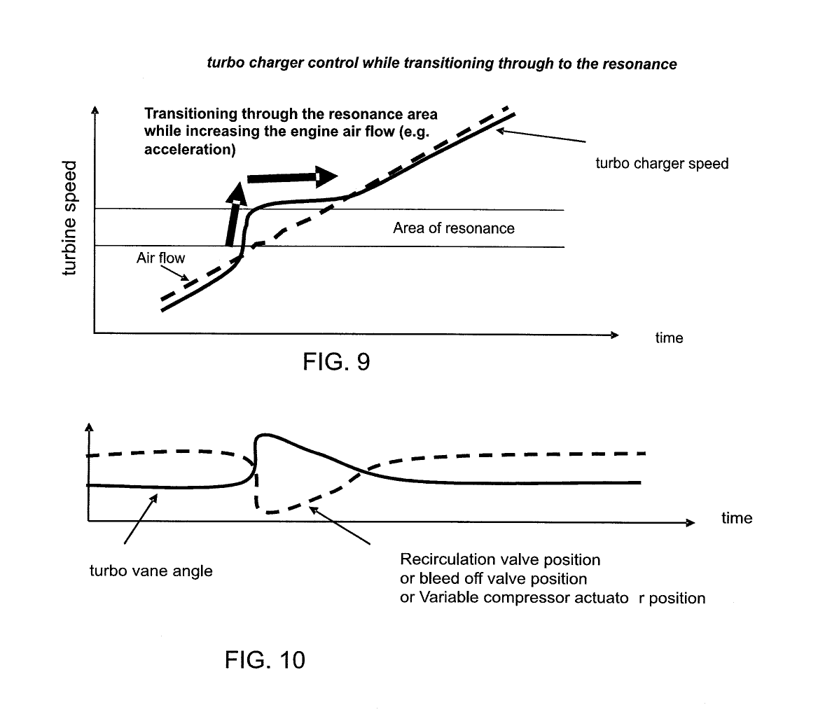

Referring now to FIG. 9 one embodiment of the invention includes controlling the turbocharger to transition through a resonance area during an increase in engine air flow such as when the engine is accelerating. In one embodiment of the invention the turbocharger is controlled with respect to an anticipated air flow requirement needed by the engine. For example, if the anticipated air flow is expected to increase as shown by the dashed line in FIG. 9, an estimate of the projected change in turbine speed is made or a projected turbine speed path is determined and a determination is made as to whether the projected change in turbine speed or the projected turbine speed path will cause the turbine speed to go through an area of resonance (speed associated with undesirable bending modes). If so, the path of the turbine speed is changed by increasing the speed of the turbine to rapidly move through or jump past the resonance area. Thereafter the speed of the turbine may be maintained, the rate of increase in speed is changed or decreased until the turbine speed meets up with the projected path of turbine speed needed to meet the air flow demanded by the engine. Thereafter, the turbine speed may be control to flow along the projected turbine speed path needed to meet the increase in air flow into the engine. Excess air produce by the compressor when the turbine speed is greater that that needed to meet the air flow demand of the engine may be utilized in any manner described herein.

Referring now to FIG. 10, one embodiment of accomplishing the alteration in turbine speed path described with respect to FIG. 9 may include changing the vane angle of the variable geometry turbine 50 (for example by using a controller) to increase or decrease the speed of the turbine to jump past the resonance speed. The split of recirculation gas flowing through the high pressure EGR line 42 or low pressure EGR line 71 may be adjusted (for example using a controller), an excess air bleed valve 67 is adjusted or a variable compressor actuator may be utilized to change vane positions of the compressor to avoid undesirable increases in air mass flow to the engine.

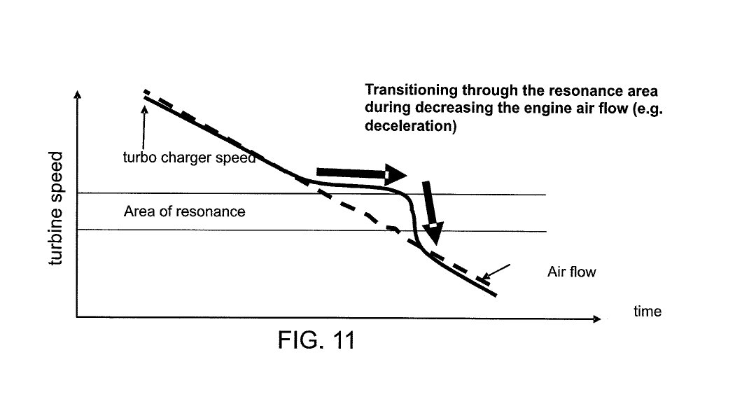

Referring now to FIG. 11, one embodiment of the invention includes controlling the turbocharger to transition through a resonance area during a decrease in engine air flow such as when the engine is decelerating. In one embodiment of the invention the turbocharger is controlled with respect to an anticipated air flow requirement needed by the engine. For example, if the anticipated air flow is expected to decrease as shown by the dashed line in FIG. 11, an estimate of the projected change in turbine speed is made or a projected turbine speed path is determined and a determination is made as to whether the projected change in turbine speed or the projected turbine speed path will cause the turbine speed to go through an area of resonance (speeds associated with undesirable bending modes). If so, the path of the turbine speed is changed by maintaining a speed or reducing the rate of decrease in turbine speed so that the speed of the turbine is greater than speeds associated with the resonance area for a period of time. Thereafter, the speed of the turbine may be rapidly decreased to rapidly move through the resonance area or jump through the resonance area so that the turbine speed meets up with the projected path of turbine speed needed to meet the projected air flow requested by the engine. Thereafter, the turbine speed may be control to flow along the projected turbine speed path needed to meet the decrease in air flow into the engine. Excess air produce by the compressor when the turbine speed is greater that that needed to meet the air flow demand of the engine may be utilized in any manner described herein.

The above description of embodiments of the invention is merely exemplary in nature and, thus, variations thereof are not to be regarded as a departure from the spirit and scope of the invention.

1. A method comprising:
providing a system comprising a combustion engine and an air intake side, an exhaust side, a turbocharger comprising a turbine and a compressor, and at least a first exhaust gas recirculation line extending between the air intake side and the exhaust side;
determining the volume of intake gas required to operate the combustion engine at a power level demanded by an operator of a vehicle;
controlling the operation of the turbocharger to adjust the speed of the turbine to an adjusted speed and wherein the adjust speed is at least one of: a speed that results in a change in efficiency of the turbocharger turbine with respect to the efficiency of the turbocharger turbine at the first speed that is an improvement in efficiency within a target percentage range for the turbocharger turbine; a speed within a range of acceptable speeds, wherein each acceptable speed has an associated acceptable resonance mode or bending mode; a speed sufficient to produce air from the compressor in an amount in excess of the volume of intake gas desired to operate the combustion engine at the power level demanded by the operator of the vehicle;
determining if the adjusted speed of the turbine produces an amount of air from the turbocharger compressor that is in excess of the volume of intake gas required to operate the combustion engine at the power level demanded by the operator of the vehicle, and delivering any excess air produced by the compressor to another component of the vehicle.

2. A method as set forth in claim 1 further comprising a second exhaust gas recirculation line downstream of the turbocharger and portioning the flow of gas through the first and second exhaust gas recirculation lines to increase the efficiency of the turbocharger or achieve a certain desired turbocharger performance.

3. A method as set forth in claim 1 wherein the turbocharger has a variable geometry and wherein the turbine comprises movable vanes or other adjustable geometry components and wherein the controlling the operation of the turbocharger so that the speed of the turbocharger turbine is at an adjusted speed comprises moving the vanes.

4. A method as set forth in claim 1 wherein the target percentage range is 1-30 percent improvement in efficiency of the turbocharger turbine.

5. A method as set forth in claim 1 wherein the system further comprises a radiator for cooling combustion engine fluid and wherein the delivering any excess air produced by the compressor to another component comprises delivering excess air produced by the compressor to flow through the radiator.

6. A method as set forth in claim 1 wherein the component comprises at least one of a first cooler in a high pressure exhaust gas recirculation line, a second cooler in a low pressure exhaust gas recirculation line or a charge air cooler in the air intake side.

7. A method as set forth in claim 1 wherein the component comprises a section of the air intake side downstream of the compressor.

8. A method as set forth in claim 1 wherein the adjusted speed is a speed that results in a change in efficiency of the turbocharger turbine with respect to the efficiency of the turbocharger turbine at the first speed that is an improvement in efficiency within a target percentage range for the turbocharger turbine.

9. A method as set forth in claim 1 wherein the adjusted speed is within a range of acceptable speed, wherein each acceptable speed has an associated acceptable resonance mode or bending mode to thereby avoid speed with associated unacceptable resonance or bending modes.

10. A method as set forth in claim 1 wherein the adjusted speed is sufficient to produce air from the compressor in an amount in excess of the volume of intake gas desired to operate the combustion engine at the power level demanded by the operator of the vehicle.

11. A method as set forth in claim 10 further comprising delivering the excess air produced by the compressor to another component.

12. (canceled)

13. A method as set forth in claim 11 wherein the component comprises at least one of a first cooler in a high pressure exhaust gas recirculation line extending between the exhaust side and the air intake side, a second cooler in a low pressure exhaust gas recirculation line extending from the exhaust side to the air intake side, or a charged air cooler in the air intake side.

14. A method as set forth in claim 11 wherein the component is a second turbocharger.

15. A method as set forth in claim 13 wherein the second turbocharger includes a compressor in fluid communication with an exhaust gas recirculation line extending between the air intake side and exhaust side to pump exhaust gas through the recirculation line and the compressor is connected to a turbine in fluid communication with a conduit with the excess flowing therethrough.

16. (canceled)

17. (canceled)

18. A method as set forth in claim 9 wherein the speed of the turbine is controlled to jump past undesirable speeds.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)
